(19) United States
(12) Patent Application Publication
(10) Pub. No.: US 2017/0362720 A1
(43) Pub. Date: Dec. 21, 2017

(54) Electrochemical Compression of Ammonia Using Ion Exchange Membranes

(71) Applicant: Xergy Inc., Georgetown (DE)

(72) Inventors: Bamdad Bahar, Georgetown, DE (US); Chunsheng Wang, College Park, MD (US)

(21) Appl. No.: 15/627,577

(22) Filed: Jun. 20, 2017

Related U.S. Application Data
(60) Provisional application No. 62/352,347, filed on Jun. 20, 2016.
(60) Provisional application No. 62/352,321, filed on Jun. 20, 2016.
(60) Provisional application No. 62/352,333, filed on Jun. 20, 2016.

(51) Int. Cl. C25B 9/10; H01M 2/16; B01D 71/14; B01D 71/28

(52) U.S. Cl. CPC C25B 9/10; H01M 2/162; B01D 71/14; B01D 71/28

(57) ABSTRACT

An electrochemical compressor utilizes a working fluid having a proton associable component, such as ammonia. Water may be reacted on a anode to form protons that are transported through an ion conducting membrane to the cathode side of the electrochemical compressor. The proton associable component of the working fluid will be pulled through the ion conducting membrane along with the proton. The ion conducting membrane may include perfluorosulfonic acid ionomer, polystyrene sufonic acid ionomer and/or carboxymethyl cellulose.

### CROSS REFERENCE TO RELATED APPLICATIONS

This application claims the benefit of priority to U.S. provisional patent application No. 62/352,347 filed on Jun. 20, 2016 and entitled Electrochemical Compression of Ammonia Using Ion Exchange Membranes, U.S. provisional patent application No. 62/352,321, filed on Jun. 20, 2016 and entitled Electrochemical Compression Using Anionic Exchange Membranes, and U.S. provisional patent application No. 62/352,333 filed on Jun. 20, 2016 and entitled Water Control In The Output Stream Of An <Electrochemical System Using Hydroscopic Barriers To Constrain Water Movement; the entirety of each of the three provisional application are hereby incorporated by reference herein.

### BACKGROUND OF THE INVENTION

### Field of the Invention

The disclosed subject matter relates to enhanced working fluid transport and compression via advanced membrane materials and construction thereof, advanced electrochemical control techniques and systems for enhanced working liquid adsorption, desorption and permeation of ions through the electroactive membrane.

### Background

The function of both refrigeration cycles and heat pumps is to remove heat from a heat source or reservoir at low temperature and to reject heat to a heat sink or reservoir at high temperature. While many thermodynamic effects have been exploited in the development of heat pumps and refrigeration cycle, one of the most popular today is the vapor compression approach. This approach is sometimes called mechanical refrigeration because a mechanical compressor is used in the cycle.

Mechanical compressors account for approximately 30% of a household's energy requirements and consume a substantial portion of most utilities based load power. Any improvement in efficiency related to compressor performance can have significant benefits in terms of energy savings and thus have significant positive environmental impact. In addition, there are increasing thermal management problems in electron circuits, which require smaller heat pumping devices with greater thermal management capabilities.

Vapor compression refrigeration cycles generally contain five important components. The first is a mechanical compressor that is used to pressurize a gaseous working fluid. After proceeding through the compression or, the hot pressurized working fluid is condensed in a condenser. The latent heat of vaporization of the working fluid is given up to a high temperature reservoir often called the sink. The liquefied working fluid is then expanded at substantially constant enthalpy in a thermal expansion valve or orifice. The cooled liquid, working fluid is then passed through an evaporator. In the evaporator, the working fluid absorbs its latent beat of vaporization from a low temperature reservoir often called a source. The last element in the vapor compression refrigeration cycle is the working fluid itself.

In conventional vapor compression cycles, the working fluid selection based on the properties of the fluid and the temperatures of the heat source and sink. The factors in the selection include the specific heat of the working fluid its latent heat or vaporization, its specific volume and its safety. The selection of the working fluid affects the coefficient of performance of the cycle.

For a refrigeration cycle operating between a lower limit, or source temperature, and an upper limit, or sink temperature, the maximum efficiency of the cycle is limited to the Carnot efficiency. The efficiency of a refrigeration cycle is generally defined by its coefficient of performance, which is the quotient of the heat absorbed from the sink divided by the net-work input required by the cycle.

Any improvement in refrigeration systems clearly would have substantial value. Electrochemical energy conversion is considered to be inherently better than other systems because due to their relatively high exergetic efficiency. In addition, electrochemical systems are considered to be noiseless, modular, and scalable and can provide a long list of other benefits depending on the specific thermal transfer application.

This invention relates to the application of electrochemical energy conversion systems for use within refrigeration cycles. Enhancing working fluid transport and compression via advanced membrane materials and construction thereto advanced electrochemical control techniques and systems for enhanced working fluid adsorption, desorption and permeation through the electroactive membrane.

### SUMMARY OF THE INVENTION

An exemplary working fluid for an electrochemical compressor comprises a proton, associable component, such as Ammonia. Ammonia has both a very strong dipole moment that orients the molecule with the proton electric field and unshared electrons that associate with the proton ordinate covalent or hydrogen bonding. Ammonia migrates through an electrolyte, such as a proton conducting membrane, as an ammonium ion and is pressurized on the cathode side when released from the association with the proton as it is converted back to hydrogen gas at a higher pressure. Ammonia is a condensable refrigerant component in a standard vapor phase compression heat pump cycle when released from their proton association at the cathode electrode. The ionized molecule migrating though the membrane also carries with it a shell of uncharged working fluid analogous to the solvated proton.

In the most straight forward embodiment, an electrochemical compressor and heat pump system include an electrochemical cell and a mixed gas refrigerant based cooling system. The electrochemical cell is capable of producing high pressure gas from a mixed fluid system including an electrochemically-active component such as hydrogen and at least one refrigerant fluid. The cooling system can include a condenser, compressor, and evaporator in thermal, communication with an object to be cooled. Hydrogen and a working fluid are pressurized across the membrane electrode assembly. The hydrogen and the working fluid enter a gas space adjacent to the cathode, where it is compressed into a vapor refrigerant. As the vapor refrigerant is compressed, it is forced through the condenser where the refrigerant is liquefied. The liquid refrigerant then passes through the evaporator where the liquid refrigerant is evaporated by absorbing heat from the object to be cooled. The mixed fluids then enter the electrochemical cell where hydrogen and the working fluid are pressurized again.

The electrochemical compressor raises the pressure of the worrking fluid which is then delivered to a condenser where the condensable component is precipitated by heat exchange with, a sink fluid. The working fluid is then reduced in pressure in a thermal expansion valve and the lower pressure working fluid is delivered to an evaporator where the condensed phase of the working fluid is boiled by heat exchange with a source fluid or heat source. The evaporator effluent working fluid, may be partially in the gas phase and partially in the liquid phase when it is returned from the evaporator to the electrochemical compressor. In the process heat energy is transported from the evaporator to the condenser and consequently, from the heat source at low temperature to the hear sink at high temperature.

Hydrogen is not a suitable refrigerant for many applications Prior art patents show various schemes for combining a refrigerant with a high pressure gas stream to produce a combined high pressure gas stream suitable for the, next stage in a refrigeration cycle. Generally, non proton associable refrigerants, non-hydrogen, bypasses the electrochemical cell, while proton, associable substance such methanol or water is provided that travels across a cell without dissociating into an ionic species at the anode as part of a solvation shell that moves with protons (i.e. dissociated hydrogen). This invention provides a mixed working fluid, wherein a proton associable component moves through the electrolyte or ion conducting membrane. This is accomplished by both association with protons and osmotic drag, and also by electroosmotic pumping by utilizing composite membranes so the total membrane acts in a dual manner, both protonic driven flux as well as the flux generated by the electric field.

Protonic driven drag and electric field driven flux and assisted membrane sorption/desorption enable a proton associable component of a working fluid to pass through the electrolyte or ion conducting membrane without the need for a bypass. Advanced components developed for fuel cells employing advanced ionomer membranes to provide electrochemical (EC) compression of working fluids operating cyclic refrigeration are based on membranes that are designed to be hypotonic, that is the membrane is hydrated and if is operation in optimal form for a fuel cell the water or hydration which gives the proton mobility stays within the membrane. Current membranes while much superior in that respect than those of only a few years ago, still pass moisture and which must be replenished from both or either the anodic humidified hydrogen or the cathodic generated water. One property of ionomer membranes when combined with gas diffusion electrodes, and in particular of perfluorosulfonic (PFSA) membranes, is their ability to absorb polar liquids, and transport ions through these liquids with an electric field. An electrochemical compressor may use an appropriate ionomer to transport a proton alone, along with an ammonia working fluid from a region where there is a heat source, to a region where it can release thermal energy efficiently. Its subsequent reintroduction to the heat-source region, where it can, reabsorb more heat again, completes the refrigeration cycle. This cycle can employ a working fluid in a single state, such as hydrogen entirely in gas-phase, or can engage a working, coexisting, fluid that changes its state, as a refrigerant does in a traditional refrigeration cycle.

One common ionomeric membrane is a perfluorosulfonic acid (PFSA) ionomer that is available as a sheet and which is a synthetic polymer with proton conducting properties. The ionic properties of PFSA result from incorporating perfluorovinyl ether groups terminated with sultanate groups onto a tetrafluoroethylene (Teflon) backbone. Membranes utilizing PFSA ionomer have received considerable attention as proton conductors for polymer electrolyte membrane (PEM) fuel cells because of the thermal and mechanical stability. This combination of physical stability and ionic conduction enables these membranes to be suitable for these devices. A PFSA may be incorporated into a support structure, such as an expanded polytetrafluoroethylene (PTFE) membrane.

In a fuel cell, protons on the SO3H sulfonic acid groups, hop from one acid site to another. Pores allow movement of cations within a polar layer, typically water imbibed in the membrane. A critical requirement of these cells is to maintain a high water, or polar-liquid, content in the electrolyte. This ensures high ionic conductivity. The ionic conductivity of the electrolyte is higher when the membrane is fully saturated which offers a low resistance to current flow and increases overall efficiency.

Contributing factors to water or polar-liquid transport, arc: (1) associated-drag through the cell, (2) back diffusion from the cathode, and (3) diffusion or any polar-liquid in the fuel stream through the electrode.

Liquid transport is a function of cell current and the characteristics of membranes and electrodes. Liquid drag refers to the amount or a polar component pulled by osmotic action along with the proton. Between 1 and 5 molecules are dragged with each proton. As a result, the ion exchanged can envisioned as a solvated (S) proton, H(S)n+. Drag that potentially increases at higher current density compared to actual operation where there is also back diffusion of liquid from electrode to electrode requires investigation. In effect, the solvated proton migrates from one electrode to the other under an electric field, within a sea or polar-liquid (i.e. water and ammonia combined). The membrane electrode assemblies (MEAs), used specifically require high rates hydration with both water and ammonia. Hydration rates can be increased by increasing the number or sulfonic acid groups within the membrane, sometimes referred to as a decrease in Equivalent Weight (EW). The MEAs are thus preferentially lower EW membranes, than coventional membranes used in fuel-cells. In addition, in some direct methanol fuel-cells, methanol migration from one electrode to another is impeded by careful design of the membrane media. In this case, the opposite, active migration from anode to cathode, is desired. Based on biological literature the utilization of highly permeable membranes, which would have high back flow, coupled with active protonic pumping and control provides for very high forward pumping rates. The key is the selection or appropriate membranes and active control of the membrane permeation with appropriate electrical waveforms.

An embodiment of the present invention provides a device that uses similar ionomer membrane with electrode attachments (an MEA) as the hydrogen working fluid pump. One utilization of this component is in a traditional four-stage refrigeration cycle system. The surface being cooled will act as, an evaporator unit. Condensation will occur beyond the membrane surface. One approach to the stages of condensation and expansion, involves using a heat-exchanger surface in the device, with subsequent expansion utilizing a micro-machined orifice, or to install an orifice-tube to act as a refrigeration-cycle expansion valve.

An embodiment of the present invention utilizes direct protonic pumping via solvation shell (electroosmotic drag). Since the electrochemical regime is not aggressive as in a typical fuel cell, a wide range of ionomer can be selected. Therefore, this invention includes the extension of ionomers to water soluble ionomers. Two commercially available materials examples include: Polystyrene sulfonic acid (PSSA) and carboxymethyl cellulose (CMC). They are not only much less expensive than perfluorosulfonic acid ionomer, but also of lower EW (about EW=200) and therefore more conductive and can thus allow the system to operate at higher current densities. Both are available from Aldrich: PSSA as 18% solution or the free acid in H2O, and as 30% solution of the NH4+ salt. This ionomer is the non-crosslinked version of conventional ion exchange resins. Another ionomer is CMC which is available at 250000 MW and DS=1.2 and available in the Na+ salt form. This can also be converted to the free acid or NH4+ salt. It is clear that there are wide arrays of materials and that someone skilled in the art can conceive or various ways to accomplish the core requirements of the membrane envisaged in this invention. The examples above are merely illustrations and should not be considered limitations in anyway.

Generally, ionomer can be film cast to establish membranes. Casting methods do generally provide different physical properties. Typically, thin films of ionomer can be brittle and/or mud crack; thus it is preferred that they be dissolved in methanol and recast. Films can be cast on glass, both CMC and PFSA to not release easily from glass. Optionally, films can be cast on non-stick surfaces such as on a fluoropolymer including PTFE or FEP or Polyolefin films. Another option is to cast the films with in the matrix of a porous membrane such as a very open porous structure of expanded PTFE, with interconnected nodes arid fibrils, or another porous media such as polyethylene membrane or polyester substrate or a silicate variant film. A fibrous medium such as fiber glass, ceramic fiber or polymer fiber can also be suitable. Additionally, the ionomer can be cast with fiber reinforcement in the solution such as fiber glass, PTFE fiber, or polymeric fiber or ceramic fiber etc. In essence, the idea is to reinforce the ionomer before assembly and/or during operation when solvated. Thinner membranes reduce the distance ions need to travel and as a result enhance performance. Reinforcing the membrane allows for ultra-thin membranes to be formed well below 25 microns in thickness or indeed 10 microns in thickness and ultimately less than one micron in thickness. Thus, this invention does not envision any thickness limitations. It is clear that there are wide arrays or methods and that someone skilled in the art can conceive or various methods to accomplish the core requirements of the membrane envisaged in this invention.

Note that depending on what ionomer or ionomers are used similar or at least compatible ionomers, need to be used as binder with catalyst in the electrode for the membrane electrode assembly. Such electrode inks can be sprayed onto the membrane or printed onto the membrane or a suitable substrate or even cast and then pressed against the membrane with assured bonding. It is clear that there are wide arrays of method and that someone skilled in the art can conceive or various methods to accomplish the core requirements or the membrane envisaged in this invention.

Note that ensuring anode and cathode chemical stability is vital, and optionally different ionomer(s) blends may be used for different sides.

In terms or specific catalyst in the electrochemical compressor the anode catalyst performs the similar function as in a fuel cell: H2→2H+2e−. The cathode catalyst perform the same function as in a water electrolyze, namely the reverse of the above equation. Thus, while in a fuel cell it is typical for high loading of precious metal catalysts to be employed, on both electrodes in the ECC there is a wider (lower cost and lower loading) set or options. Indeed, in water electrolysis catalyst combinations such as NiMo are more prevalent and are clearly lower cost than platinum. Obviously therefore this invention envisages hybrid membrane electrode assemblies optimized for performance and lowest cost. It is clear that there are wide arrays of catalysts and methods and that someone skilled in the art can conceive to accomplish the core requirements of the membrane envisaged in this invention.

A cell assembled with the components identified herein, is then combined to form an electrochemical compressor device and then subsequently used in a variety of different refrigeration cycles, such as for example, in a refrigerator or heat pump, or automobile, or electronic cooling application. This invention provides not only the materials mixtures for creating the membranes the membrane systems, the device, the control system for enhanced sorption/desorption, the specific system for creating and controlling the electrical superposition and application of a complex waveform to the electrodes of the proton/working fluid pump and also the application of the device within a large spectrum of functions including but not limited to pumping of fluid, vapor and it's use in a vapor phase compression cycle application.

This application incorporates by reference, in their entirety, the following: U.S. Pat. No. 9,151,283 issued on Oct. 6, 2016 and entitled Electrochemical Motive Device, U.S. Pat. No. 8,769,972, issued on Jul. 8, 2014 and entitled Electrochemical Compressor and Refrigeration System, U.S. Pat. No. 8,640,492, issued on Feb. 4, 2014 and entitled Tubular System For Electrochemical Compressor, U.S. Pat. No. 9,464,822, issued on Oct. 11, 2016, Electrochemical Heat Transfer System, and U.S. Pat. No. 9,599,364, issued on Mar. 211, 2017, Electrochemical Compressor Based Heating Element And Hybrid Hot Water Heater Employing Same, U.S. Pat. No. 8,627,671, issued on Jan. 14, 2014 and entitled Self-Contained Electrochemical Heat Transfer System, U.S. Pat. No. 9,151,283, issued on Oct. 6, 2015 and entitled Electrochemical Motive Device, U.S. Pat. No. 9,457,324, issued on Oct. 4, 2016 and entitled Active Components and Membranes For Electrochemical Compression, and U.S. Pat. No. 9,005,411, issued on Apr. 14, 2015 and entitled Electrochemical Compression System.

The summary of the invention is provided as a general introduction to some of the embodiments of the invention, and is not intended to be limiting. Additional example embodiments including variations, and, alternative configurations of the invention are provided herein.

### BRIEF DESCRIPTION OF SEVERAL VIEW OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a diagram of an exemplary electrochemical compressor.

FIG. 2 shows a diagram of an exemplary electrochemical compressor refrigeration system comprising a membrane electrode assembly (MEA) comprising a electrochemical cell for producing a flow of pressurized working fluid.

### DETAILED DESCRIPTION OF THE ILLUSTRATED EMBODIMENTS

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As used herein, the terms “comprises,” “comprising, includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications and improvements are within the scope of the present invention.

As used herein, the term consists essentially of, as used to describe the ion conducting membrane means that the ion conducting polymer of the ion conducting membrane is at least 80% the polymer stated, and more preferably at least 90% and even more preferably at least 95% by weight of the ion conducting polymer portion of the ion conducting membrane, which does not include a support material, such as expanded PTFE.

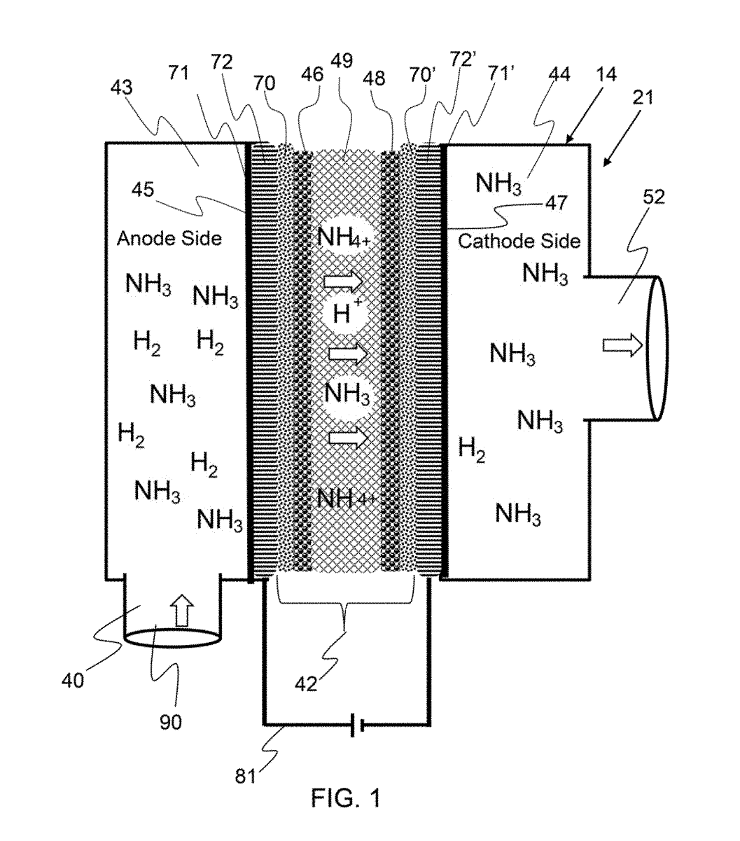

Referring now to FIG. 1, an exemplary electrochemical compressor 21 and an electrochemical cell 14 comprising an electrolyte, an ion conducting membrane 49, disposed between the anode side 45 and cathode side 47 of the electrochemical cell. The working fluid 90 comprises ammonia and enters the electrochemical compressor through inlet 40. The hydrogen is reacted on the anode 46 to produce H+ ions, or protons, that are passed through the ion conducting membrane to the cathode 48, where they reform into hydrogen. The ammonia may associate protons to form ammonium NH4+ and be dragged through the ion conducting membrane. The cell further comprises a flow field 71 with flow channels 72 to distribute the working fluid to the anode and cathode, and a gas diffusion media 70. The gas diffusion media is porous to allow the transfer of gas and liquid to the electrodes. The anode chamber 43 is the lower pressure side of the electrochemical cell and the, cathode chamber 44 is a higher pressure side of the electrochemical cell. The working fluid inlet 40 to the anode side feeds in the working fluid which may include ammonia that is transported through a pump or refrigeration system before returning to the inlet 40. The outlet conduit 52 of the electrochemical cell is at a high pressure than the inlet 40. The membrane electrode assembly 42 includes the ion conducting membrane 49 as well as the anode 46 and cathode 48. The power supply 81 produces a voltage differential between the anode and cathode to drive the reactions that cause the working fluid to pass from the anode to the cathode.

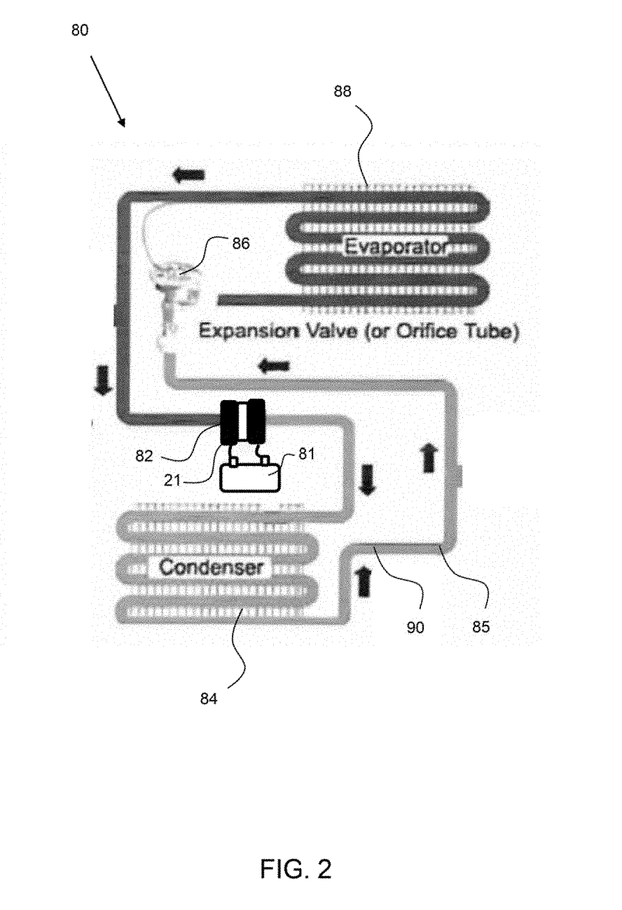

FIG. 2 shows a diagram of an exemplary electrochemical compressor refrigeration system 80 comprising an electrochemical compressor 21 utilizing a membrane electrode assembly 82 (MEA), such as shown in FIG. 1. The electrochemical compressor uses a power supply 81 to create a flow of pressurized working fluid 90. The working fluid is transferred by the MEA to the high pressure side and to the condenser 84. The condensed working fluid is then transferred through conduits 85 to the expansion valve 86 and then to the evaporator 88. The working fluid then returns to the anode side, or low pressure side, of the electrochemical compressor.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. An electrochemical compressor comprising:
a working fluid comprising:
ammonia; and
hydrogen;
one or more electrochemical cells electrically connected to each other through a power supply,
each electrochemical cell comprising:
a gas pervious anode,
a gas pervious cathode,
an electrolyte disposed between and in intimate electrical contact with the cathode and the anode;
a) an electrochemical compressor input for receiving aid working fluid;
wherein the ammonia and hydrogen are transferred through the electrolyte from the anode to the cathode to create a high pressure side of the of the electrochemical cell.

2. The electrochemical compressor of claim 1, wherein the electrolyte is an ion conducting membrane.

3. The electrochemical compressor of claim 1, wherein the ion conducting membrane comprises perfluorosulfonic acid ionomer.

4. The electrochemical compressor of claim 1, wherein the ion conducting membrane comprises perfluorosulfonic acid ionomer.

5. The electrochemical compressor of claim 1, wherein the ion conducting membrane comprises polystyrene sulfonic acid ionomer.

6. The electrochemical compressor of claim 1, wherein the ion conducting membrane comprises carboxymethyl cellulose.

7. The electrochemical compressor of claim 1, wherein the ion conducting membrane consists essentially of polystyrene sulfonic acid ionomer.

8. The electrochemical compressor of claim 1, wherein the on conducting membrane consists essentially of carboxymethyl cellulose

9. A refrigeration system that conveys heat from a first heat reservoir at a relatively low temperature to a second heat reservoir at relatively high temperature, the refrigeration system defining a dosed loop that contains a working fluid, at least part of the working fluid being circulated through the dosed loop, the refrigeration system comprising:
a first heat transfer device that transfers heat from the first heat reservoir to the working fluid,
a second heat transfer device that transfers heat from the working fluid to the second heat reservoir,
an expansion valve between the first and second heat transfer devices that reduces pressure of the working fluid, a conduit system and
an electrochemical compressor between the first and second heat transfer devices;
wherein the electrochemical compressor comprises:
one or more electrochemical cells electrically connected to each other through a power supply,
each electrochemical cell comprising:
a gas pervious anode,
a gas pervious cathode,
an electrolyte disposed between and in intimate electrical contact with the cathode and the anode;
an electrochemical compressor input,
an electrochemical compressor output,
wherein the working fluid comprises:
a condensable refrigerant that essentially bypasses the electrochemical process and remains in the closed loop; and
an electrochemically active fluid that participates in the electrochemical process within the electrochemical compressor;
wherein said conduit system has a geometry that enables at least a portion of the received working fluid to be imparted with a gain in kinetic energy as it moves through the conduit system;
wherein the working fluid comprising:
ammonia; and
hydrogen;
wherein the ammonia is transferred through the electrolyte and through the conduit.

10. The refrigeration system of claim 9, wherein the electrolyte is an ion conducting membrane.

11. The refrigeration s steam of claim 9, wherein the ion conducting membrane comprises perfluorosulfonic acid ionomer.

12. The refrigeration system of claim 9, wherein the ion conducting membrane comprises perfluorosulfonic acid ionomer.

13. The refrigeration system of claim 9, wherein the ion conducting membrane comprises polystyrene sulfonic acid ionomer.

14. The refrigeration system of claim 9, wherein the ion conducting membrane comprises carboxymethyl cellulose.

15. The refrigeration system of claim 9, wherein the ion conducting membrane consists essentially of polystyrene sulfonic acid ionomer.

16. The refrigeration system of claim 9, wherein the ion conducting membrane consists essentially of carboxymethyl cellulose.
